(19) United States
(12) Patent Application Publication
(10) Pub. No.: US 2002/0043798 A1
(43) Pub. Date: Apr. 18, 2002

(54) Advertising device

(76) Inventor: David Engel, Toronto (CA)

Correspondence Address: Harness, Dickey & Pierce, P.L.C., P.O. Box 828, Bloomfield Hills, MI, 48303, US

(21) Appl. No.: 09/740,588

(22) Filed: Dec. 19, 2000

(30) Foreign Application Priority Data
Oct. 13, 2000 (CA) 2,323,165

(51) Int. Cl. G09F 1/00

(52) U.S. Cl. 283/56

(57) ABSTRACT

Disclosed is an advertising and distributing device which is adapted to be stuck on a newspaper, magazine, catalogue, envelope, parcel, package or other similarly distributed print medium. A pressure-sensitive adhesive is applied to a back face of a first layer and to a back face of a second layer with located in between the promotional material per se. Preferably, there is also provided a peel off layer to which is attached the back of the second A device for advertising and distributing printed materials including at least one printed material, said device having a first layer having an adhesive applied to one surface thereof, a second layer having an adhesive applied to one surface thereof and a peel off layer, said peel off layer protecting said adhesive surface of said second layer prior to affixing to a host layer prior to removal for sticking to the print medium.

### FIELD OF THE INVENTION

The present invention relates to the field of advertising and distribution vehicles, and provides a device for placement on the cover of a host such as newspaper, magazine, catalogue, envelope, parcel, package or other similar distributed print medium for commercial purposes.

### BACKGROUND OF THE INVENTION

It is known, using inserts, to conduct direct mail advertising campaigns, wherein promotional materials are distributed to a large number of individuals and potential customers. Some of the drawbacks of this type of advertisement or sample are that very often, the materials will be lost in transit or discarded before being read. Moreover, such inserts are often big and cumbersome, and expensive to produce.

### SUMMARY OF THE INVENTION

The object of the present invention is to provide a product adaptable to a variety of print medium which will not get lost or fly away.

The object of the present invention is to provide a form of advertising or a sample which is either personalized or of a general nature and which overcomes the above shortcomings.

In a first broad aspect, the present invention relates to a device for advertising and distributing printed materials including at least one printed material, said device having a layer onto which is securely positioned said printed material, said layer being adhesively affixed onto a host.

In a broad aspect, the present invention relates to a device for advertising and distributing printed materials including at least one printed material, said device having at least two layers between which is securely positioned said printed material before adhesively affixing onto a host, one of said two layers being closest to said host at least partially remaining onto the host upon removal of the printed material.

In a further aspect, then, the present invention relates to a device for advertising and distributing printed materials including at least one printed material, said device having a first layer having an adhesive applied to one surface thereof, a second layer having an adhesive applied to one surface thereof and a peel off layer, said peel off layer protecting said adhesive surface of said second layer prior to affixing to a host.

In a still further aspect of the present invention there is provided a method of advertising and distributing printed materials utilizing a host comprising the steps of: preparing a printed material; applying a first layer to said printed material; affixing said first layer to a second layer; and adhesively positioning said second layer onto said host; whereby said printed material being sandwiched between said first and second layers is securely affixed to said host.

Further objects and advantages of the present invention will be apparent from the following description, wherein preferred embodiments of the invention are clearly shown.

### BRIEF DESCRIPTION OF THE DRAWINGS

The present invention will be further understood from the following drawings that illustrate the present invention by way of example:

FIG. 1 is a front view of an advertising device according to the present invention;

FIG. 2 is a sectional view through line II-II of the device of FIG. 1;

FIG. 3 is a front view of the device of FIG. 1, in an open condition; and

FIG. 4 is a perspective view of a publication bearing the device of FIG. 1 on its cover.

### DETAILED DESCRIPTION OF THE PREFERRED EMBODIMENT

Referring to the drawings, the device 10 of the present invention is an advertising and distributing pouch for placement on, or in a host such as a newspaper, magazine, publication, envelope, parcel, package or the like. As shown in FIG. 4, the device 10 is preferably affixed to the cover of a popular newspaper N, subscribed to by a person or purchased at a news stand, for instance. It will also be understood that the device 10 of the present invention may be specifically affixed to a page containing an advertisement placed by the advertiser sponsoring the device.

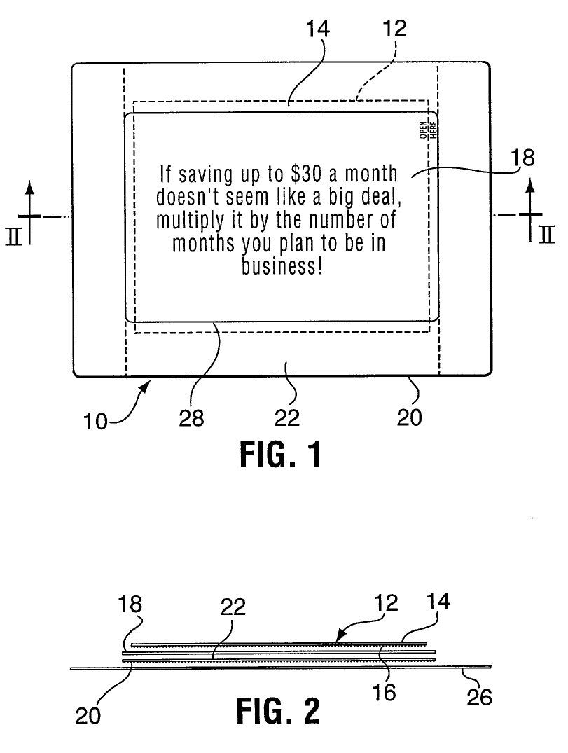

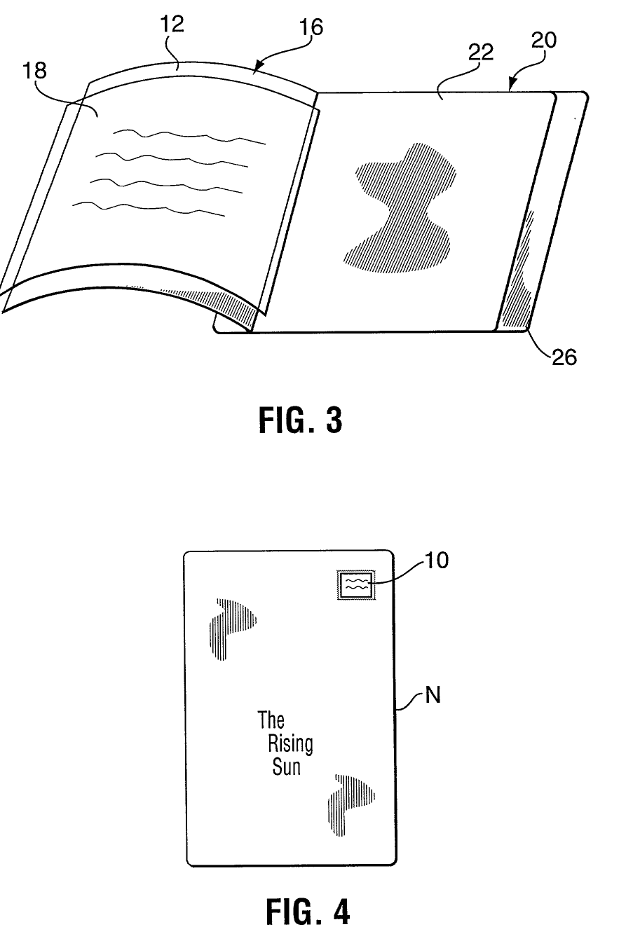

Referring to FIGS. 1, 2 and 3, the device 10 is provided with a transparent first or front layer 12 having a front face 14 and a pressure-sensitive adhesive back face 16 to which is attached the printed material 18, which can take the form of a sample, for distribution. A transparent second or back layer 20 is provided having a front face 22 and a pressure-sensitive adhesive back face 24 for securing the device 10 to a print medium N or host such as a newspaper for distribution to potential customers of the product being advertised.

As can be seen, the printed material 18 is effectively sandwiched between the back face 16, to which it is adhesively connected, and front face 22. It should be noted that the use of adhesive is not to be seen as restrictive and that other means may be used instead where and when appropriate.

A peel off layer 26 is also provided, which is adhesively connected to the back face 24 of second layer 20 until one is ready to remove it for positioning and affixing the device 10 to the medium N. Layer 26 is seen as extending beyond the edges of back layer 20 for easy removing prior to positioning.

In its most basic form, the top and bottom portions 28 of first layer 12 will extend beyond the printed material 18 providing for adhesive securement of said first layer 12 to back layer 20 thereby resulting in the desired sandwiched printed material 18. The side edges of material 18 are however free, so that material 18 may be accessed. Further, the first layer's 12 front face 14 will act as a protective barrier against transport and handling hazards thereby keeping the printed material 18 fresh and professional looking.

In practice, a printed material 18 is first produced according to the advertiser's requirements which printed material 18 can also be personalised, if so desired. For instance, a first printed material can be addressed to household X, whereas a different and relevant second printed material can be addressed to household Y, etc. A transparent first layer 12 is then adhesively applied to said material 18 which is then affixed to a transparent second layer 20. A peel off layer 26 is removed from the back face 24 of said second layer 20 revealing a pressure-sensitive adhesive which is to be positioned in a desired location for affixing to a printed medium N or host, as requested by the advertiser. It follows that at least part or all of layer 20, the layer closest to the host, remains in contact with said host once the printed material 18 has been removed therefrom. Also, it should be noted that the printed material 18 and first layer 12 can be formed as a combination whereby the first layer 12 is merely there to protect the printed material 18 during transit resulting in that once the printed material 18 is removed we end up with only one combined segment. Furthermore, first layer 12 may be done away with completely resulting in the printed material 18 being directly attached to the second layer 20. In both these embodiments, it can be said that the printed material 18 is not actually sandwiched between layers of the device 10.

It will be understood that the present invention, as described may be modified in many ways without departing from the spirit of the invention. For instance, more internal layers may be provided, to insert different sets of printed materials, but the remaining features still utilized. The present embodiments are therefore to be considered as illustrative and not restrictive, the scope of the invention being indicated by the appended claims rather than by the foregoing description, and all changes that come within the meaning and range of equivalency of the claims are therefore intended to be embraced therein.

The embodiments of the invention in which an exclusive property or privilege is claimed are defined as follows:

1. A device for advertising and distributing printed materials including at least one printed material, said device having a layer onto which is securely positioned said printed material, said layer being adhesively affixed onto a host.

2. A device according to claim 1, wherein said layer is transparent.

3. A device according to claim 1, wherein said host is a newspaper, envelope, parcel, package or other publication.

4. A device according to claim 1, wherein said printed material is personalized.

5. A device for advertising and distributing printed materials including at least one printed material, said device having at least two layers between which is securely positioned said printed material before adhesively affixing onto a host, one of said two layers being closest to said host at least partially remaining onto the host upon removal of the printed material.

6. A device according to claim 5, wherein said one layer being closest to said host wholly remains onto the host upon removal of the printed material.

7. A device according to claim 5, wherein said layers are transparent.

8. A device according to claim 5, wherein said host is a newspaper, envelope, parcel, package or other publication.

9. A device according to claim 5, wherein said printed material is personalized.

10. A device for advertising and distributing printed materials including at least one printed material, said device having a first layer having an adhesive applied to one surface thereof, a second layer having an adhesive applied to one surface thereof and a peel off layer, said peel off layer protecting said adhesive surface of said second layer prior to affixing to a host.

11. A device according to claim 10, wherein first and/or second layers are transparent.

12. A device according to claim 10, wherein top and bottom portions of said first layer extend beyond said printed material providing for adhesive securement of said first layer to said second layer effectively removably sandwiching said printed material.

13. A device according to claim 10, wherein said peel off layer extends beyond the edges of said second layer for easy handling.

14. A device according to claim 10, wherein said host is a newspaper, envelope, parcel, package or other publication.

15. A device according to claim 10, wherein said printed material is a sample.

16. A device according to claim 10, wherein said printed material is personalized.

17. A method of advertising and distributing printed materials utilizing a host comprising the steps of:
a) preparing a printed material;
b) applying a first layer to said printed material;
c) affixing said first layer to a second layer; and
d) adhesively positioning said second layer onto said host;
whereby said printed material being sandwiched between said first and second layers is securely affixed to said host.

18. A method according to claim 17, wherein first and/or second layers are transparent.

19. A method according to claim 17, wherein top and bottom portions of said first layer extend beyond said printed material providing for adhesive securement of said first layer to said second layer effectively removably sandwiching said printed material.

20. A method according to claim 17, wherein said host is a newspaper, envelope, parcel, package or other publication.

21. A method according to claim 17, wherein said printed material is a sample.

22. A method according to claim 17, wherein said printed material is personalized.
